(19) United States
(12) Patent Application Publication
(10) Pub. No.: US 2023/0037149 A1
(43) Pub. Date: Feb. 2, 2023

(54) SHAVING DEVICE

(71) Applicant: The Gillette Company LLC, Boston, MA (US)

(72) Inventors: Peter Bodo Gluche, Bellenberg (DE); Ralph Gretzschel, Neu-Ulm (DE); Michael Mertens, Vöhringen/Illerberg (DE); Matthias Gester, Farnborough (GB)

(21) Appl. No.: 17/966,357

(22) Filed: Oct. 14, 2022

(30) Foreign Application Priority Data
Apr. 16, 2020 (EP) 20169937.8

(51) Int. Cl. B26B 21/56; B26B 21/40

(52) U.S. Cl. CPC B26B 21/56; B26B 21/4031; B26B 21/58

(57) ABSTRACT

The present invention is directed to a shaving device including a housing with a skin contacting surface and at least one cutting blade mounted in the housing, wherein the at least one cutting blade has an asymmetric cross-sectional shape with a first face, a second face opposed to the first face as well as a cutting edge at the intersection of the first face and the second face. The blade is mounted in the housing such that the clearance angle α between the skin contacting surface and the primary bevel of the first face or the secondary bevel of the second face is ≤11°, the effective cutting angle ε between the skin contacting surface and the bisecting line of the first wedge angle θ₁ between the first surface and the primary bevel is ≥10° and θ₁>second wedge angle θ₂ between the first surface and secondary bevel.

### FIELD OF THE INVENTION

The present invention relates to a shaving device for shaving a skin surface with improved cutting blades and geometry.

### BACKGROUND OF THE INVENTION

In the prior art, the arrangement of the blades within a shaving device has focused on multi-blade razors.

U.S. Pat. No. 3,863,340 teaches a plural edge razor with a lead blade member and a following blade member, wherein the members have unsymmetrical edges hereon and have passages therethrough to facilitate removal of shaving debris from the cutting edge.

U.S. Pat. No. 6,655,030 describes a shaving head with at least a first and second cutting member arranged behind and spaced apart from the first cutting member wherein the cutting angle between the skin contacting surface and the second cutting member is equal or higher than the cutting angle between the skin contacting surface of the first cutting member.

U.S. Pat. No. 3,842,499 refers to a razor blade assembly with one or more groups of multiple cutting edge wherein the group of cutting elements comprises at least two blades with one blade being chisel shaped. This allows a favorable geometry for tandem blade shaving operations.

Improvements are needed in the geometry and interrelationship of the various parts of the razor blade assembly to improve shaving performance. The blades of the prior art, combination with the geometries of the prior art, often tend to disadvantageously ride over the hair without penetrating and cutting through. Due to these drawbacks, a shaving device with an optimized geometrical arrangement allowing a low cutting force and a high cutting efficiency to ensure sufficient safety for the skin is desired.

### SUMMARY OF THE INVENTION

The present invention is directed to a shaving device for shaving a skin surface including a housing with a skin contacting surface and at least one cutting blade mounted in the housing, wherein the at least one cutting blade has an asymmetric cross-sectional shape with a first face, a second face opposed to the first face as well as a cutting edge at the intersection of the first face and the second face wherein the first face comprises a first surface and a primary bevel with the primary bevel extending from the cutting edge to the first surface, a first intersecting line connecting the primary bevel and the first surface and a first wedge angle θ₁ between an imaginary extension of the first surface and the primary bevel and the second face comprises a secondary bevel with the secondary bevel extending from the cutting edge and a second wedge angle θ₂ between the first surface and the secondary bevel.

In another aspect, the present invention provides the at least one cutting blade mounted in the housing such that the clearance angle α between the skin contacting surface and the primary bevel or the secondary bevel is ≤11°, the effective cutting angle ε between the skin contacting surface and the bisecting line of the first wedge angle θ₁ is ≥10° and θ₁>θ₂.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

While the specification concludes with claims particularly pointing out and distinctly claiming the subject matter which is regarded as forming the present invention, it is believed that the invention will be better understood from the following description which is taken in conjunction with the accompanying drawings in which like designations are used to designate substantially identical elements, and in which:

FIG. 1 is a perspective view of a shaving device according to the present invention.

FIG. 2 is a cross-sectional view of the shaving device according to FIG. 1 along the line A-A.

FIG. 3a is a perspective view of a cutting blade in accordance with the present invention having 2 bevels.

FIG. 3b is a cross-sectional view of a cutting blade in accordance with the present invention having 2 bevels.

FIG. 4a is a perspective view of a shaving device in accordance with the present invention having 3 bevels.

FIG. 4b is a cross-sectional view of a shaving device in accordance with the present invention having 3 bevels.

FIG. 5a is a cross-sectional view of a further cutting blade in accordance with the present invention which is monolithic.

FIG. 5b is a cross-sectional view of a further cutting blade in accordance with the present invention out of a first and a second material.

FIG. 6a is a cross-sectional view of a shaving device in accordance with the present invention with the first face being the clearance face and a clearance angle α>0°.

FIG. 6b is a cross-sectional view of a further shaving device in accordance with the present invention with the second face being the clearance face and a clearance angle α>0°.

FIG. 7a is a cross-sectional view of a shaving device in accordance with the present invention with the first face the clearance face and a clearance angle α=0°.

FIG. 7b is a cross-sectional view of a further shaving device in accordance with the present invention with the second face being the clearance face and a clearance angle α=0°.

FIG. 8 is a cross-sectional view of a further shaving device in accordance with the present invention with the second face being the clearance face and a clearance angle α<0°.

FIG. 9a-d is a flow chart of the process for manufacturing the cutting blades.

FIG. 10 is a cross sectional view of a round tip showing the determination of the tip radius.

The following reference signs are used in the figures of the present application.

### REFERENCE SIGN LIST

1 blade
2 first face
3 second face
4 cutting edge
5 secondary bevel
6 tertiary bevel
7 primary bevel
8 upper surface
9 first surface
11 second intersecting line
12 first intersecting line
15 blade body
18 first material
19 second material
20 boundary surface
60 bisecting line
61 perpendicular line
62 circle
65 construction point
66 construction point
67 construction point
100 razor
150 grip
200 housing
210 forward skin support
220 rearward skin support
250 skin contacting surface
260 bisecting line
300 hair
310 skin

### DETAILED DESCRIPTION OF THE INVENTION

The present invention relates to a shaving device for shaving a skin surface including a housing with a skin contacting surface and at least one cutting blade mounted in the housing, wherein the at least one cutting blade has an asymmetric cross-sectional shape with a first face, a second face opposed to the first face as well as a cutting edge at the intersection of the first face and the second face.

The following definitions are used in the present application:
the rake face is the surface of a cutting blade over which the cut hair slides that is removed in the cutting process
the clearance face is the surface of a cutting tool that passes over the skin; the angle between the clearance face and the contacting surface with the skin is the clearance angle α
The cutting bevel of a cutting blade is enclosed by the rake face and the clearance face and denoted by the bevel angle θ
The cutting edge is the line of intersection of the rake face and the clearance face
The effective cutting angle ε is the angle between the skin contacting surface of the shaving device and the bisecting line of the cutting bevel, i.e., ε=α+θ/2

The dimensions of shaving blade edge profiles and their arrangement in a shaving device are interdependent and are typically optimized to cut hair efficiently. This comprises the following 3 parameters:
1. a small tip radius of the cutting edge for ease of penetration,
2. a small wedge angle θ of the cutting blade for low cutting force and
3. a large effective cutting angle ε of the blade within the shaving device, i.e., the housing, to avoid the hair rotating or sliding away before it is cut and resulting in efficient hair removal.

These definitions and parameters are illustrated in the figures of the present application.

The first two parameters result in a comfortable shave without tugging on the hairs while they are cut. However, it has been demonstrated the small tip radius of the edge together with a large blade mounting angle, i.e., the clearance angle α, creates a significant pressure onto the skin surface, which is uncomfortable and may even lead to skin being cut. Reducing the effective cutting angle ε improves the safety during shaving. Thus, in this case, conventional symmetric wedge-shaped blades tend to ride over the hair without penetrating and cutting through.

During shaving the rake face interacts with the hair and is primarily responsible for the hair cutting performance while the clearance face interacts with the skin and is primarily responsible for the safety of the skin.

For optimizing the performance of shaving, it is required to increase the safety of a shaving blade by mounting the blade at a small blade mounting angle, i.e., the clearance angle α, so that the skin facing side of the cutting blade (clearance face) lies flat on the skin (low clearance angle) and then modify the blade edge profile so that the cutting efficiency of hairs is not compromised by this small clearance angle α. This means the clearance angle α should be as small as possible to ensure skin safety and the effective cutting angle ε should be as large as possible to efficiently cut through the hair. Hence the clearance angle α plays the role of the safety angle and the effective cutting angle ε plays the role of the efficiency angle.

The clearance angle α and the effective cutting angle ε are related by

ε=α+θ/2

Hence, minimizing the clearance angle α while maintaining an effective cutting angle ε of around 22° as has been used in shaving devices successfully for a long time, requires an increase of the cutting bevel angle θ. However, the force to cut through a hair is determined by the thickness of the cutting blade near to the cutting edge and this thickness increases when the bevel angle θ of the cutting bevel is increased. Hence, increasing the bevel angle θ to maintain the cutting angle ε while reducing the clearance angle α creates a new problem of increasing cutting force and decreasing the shaving comfort due to tugging on the hair, and hence the bevel angle θ plays the role of the comfort angle.

To overcome all these interdependencies and create a cutting edge profile that has a low cutting force (small θ) a high cutting efficiency (large ε) and is safe for the skin (small α) an asymmetric cutting blade profile with at least one additional cutting bevel is disclosed.

The present invention therefore addresses the mentioned drawbacks in the prior art and provides a shaving device with an optimized geometrical setup allowing a low cutting force and a high cutting efficiency and ensuring sufficient safety for the skin.

This problem is solved by the shaving blade with the features of claim 1. The further dependent claims define preferred embodiments of such a blade.

The term “comprising” in the claims and in the description of this application has the meaning that further components are not excluded. Within the scope of the present invention, the term “consisting of” should be understood as preferred embodiment of the term “comprising”. If it is defined that a group “comprises” at least a specific number of components, this should also be understood such that a group is disclosed which “consists” preferably of these components.

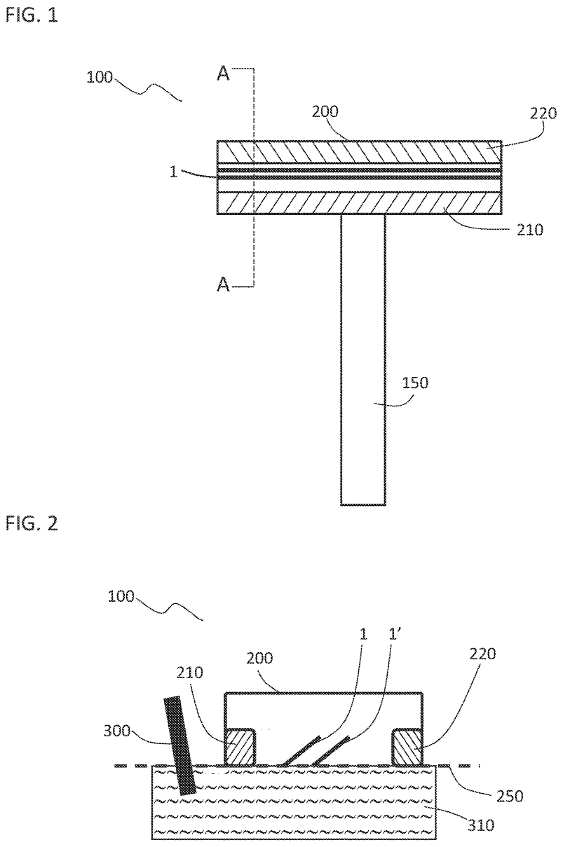

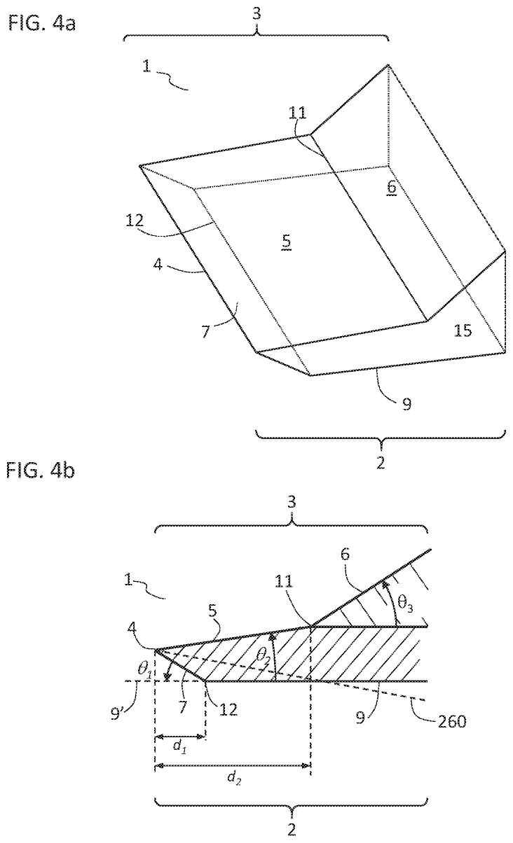

In the following, the term “intersecting line” as used herein is understood as the linear extension of an intersecting point (according to a cross-sectional view as in FIG. 3) between different bevels regarding the perspective view (as in FIG. 1). As an example, if a straight bevel is adjacent to a straight bevel the intersecting point in the cross-sectional view is extended to an intersecting line in the perspective view.

In the following, the term “cross-sectional” refers to the cross-section perpendicular to the linear extension of the cutting edge.

According to the present invention a shaving device for shaving a skin surface is provided comprising a housing with a skin contacting surface and at least one cutting blade mounted in the housing, wherein the at least one cutting blade has an asymmetric cross-sectional shape with a first face and opposed to the first face a second face as well as a cutting edge at the intersection of the first face and the second face, wherein:
the first face comprises a first surface and a primary bevel with
   the primary bevel extending from the cutting edge to the first surface,
   a first intersecting line connecting the primary bevel and the first surface and
   a first wedge angle θ₁ between an imaginary extension of the first surface and the primary bevel and
the second face comprises a secondary bevel with
   the secondary bevel extending from the cutting edge rearwards, and
   a second wedge angle θ₂ between the first surface and the secondary bevel (5).

According to the present invention the at least one cutting blade is mounted in the housing that the following conditions are met:
the clearance angle α between the skin contacting surface (250) and the primary bevel (7) is ≤11°,
the effective cutting angle ε between the skin contacting surface (250) and the bisecting line (260) of the first wedge angle θ₁ is ≥10° and
   θ₁>θ₂ and θ₂<θ₃.

It was surprisingly found that by choosing the conditions as defined above the contradictive effects of a high cutting efficiency on the one hand and a comfortable and safe cutting on the other hand are realized simultaneously.

The at least one cutting blade has an asymmetric cross-sectional shape. The asymmetrical cross-sectional shape refers to the symmetry with respect to an axis which is the bisecting line of (θ₁+θ₂)/2 and anchored at the cutting edge.

The at least one cutting blade according to the present invention has a low cutting force due to a smaller θ₂ while the cutting efficiency is high which is realized by a larger effective cutting angle ε. Moreover, the shaving device has an increased safety of the shaving process due to the small clearance angle α.

Moreover, the primary bevel may have the additional function to strengthen the cutting blade if the primary wedge angle is larger than the secondary wedge angle which allows a mechanical stabilization against damage from the cutting operation which allows a slim blade body in the area of the secondary bevel without affecting the cutting performance of the blade.

The primary bevel with the first wedge angle θ₁ has therefore the function of a stabilizing angle of the cutting edge preventing damage to the cutting edge when a hair is being cut, i.e., a bigger wedge angle θ₁ increases the mechanical stability of the cutting edge. In consequence, by using a primary bevel with the wedge angle θ₁ the second wedge angle θ₂ can be reduced.

The wedge angle θ₁ has the function to stabilize the cutting edge which allows a slim blade body in the area of the secondary bevel without effecting the cutting performance of the blade. Moreover, the primary bevel with the wedge angle θ₁ allows to lift the cutting edge from the object to be cut which makes the cutting step safer, e.g., by raising the distance between skin and cutting edge a cutting into the skin can be avoided.

The second wedge angle θ₂ represents the penetration angle of the blade penetrating in the object being cut. The smaller the penetrating angle θ₂, the lower the force to penetrate the object being cut.

It is preferred that the clearance angle α is ≤5°, preferably ≤10, more preferably ≤0° and even more preferably from −1° to −5° and/or the effective cutting angle first wedge angle ε is ≥15°, preferably ≥20°.

According to a preferred embodiment, the first wedge angle θ₁ ranges from 5° to 75°, preferably 10° to 60°, more preferably 15° to 45° and/or the second wedge angle θ₂ ranges from −5° to 40°, preferably 0° to 30°, more preferably 10° to 25°.

The cutting blades according to the present invention are preferably further strengthened by adding a thick and strong tertiary bevel that has a tertiary wedge angle greater than the secondary wedge angle and by employing this tertiary bevel to split the object to be cut, thus reducing the forces acting on the thin secondary bevel. The third wedge angle θ₃ ranges preferably from 1° to 60°, more preferably from 10° to 55°, even more preferably from 19° to 46°, and in particular from 20° to 45°

The third wedge angle θ₃ represents the splitting angle, i.e., the angle necessary to split the object to be cut. For this function the third wedge angle θ₃ has to be preferably larger than the second wedge angle θ₂.

According to a further preferred embodiment, the primary bevel has a length d₁ being the dimension projected onto the first surface of the length taken from the cutting edge to the first intersecting line from 0.1 to 7 μm, preferably from 0.5 to 5 μm, and more preferably 1 to 3 μm. A length d₁<0.1 μm is difficult to realize since an edge of such length is too fragile and would not allow a stable use of the cutting blade. It has been surprisingly found that the primary bevel stabilizes the blade body with the secondary and tertiary bevel which allows a slim blade in the area of the secondary bevel which offers a low cutting force. On the other hand, the primary bevel does not affect the cutting performance provided the length d₁ is not larger than 7 μm.

Preferably, the length d₂ being the dimension projected onto the first surface (i.e., the projection of the primary and secondary bevel) taken from the cutting edge to the second intersecting line ranges from 1 to 100 μm, more preferably from 5 to 75 μm, and even more preferably from 10 to 50 μm. The length d₂ corresponds to the penetration depth of the cutting blade in the object to be cut. In general, d₂ corresponds to at least 30% of the diameter of the object to be cut, i.e., when the object is human hair which typically has a diameter of around 100 μm the length d₂ is around 30 μm.

The cutting blade is preferably defined by a blade body comprising or consisting of a first material and a second material joined with the first material. The second material can be deposited as a coating at least in regions of the first material, i.e., the second material can be an enveloping coating of the first material or a coating deposited on the first material on the first face.

The material of the first material is in general not limited to any specific material as long it is possible to produce a bevel using this material.

However, according to an alternative embodiment the blade body consists only of the first material, i.e., an uncoated first material. In this case, the first material is preferably a material with an isotropic structure, i.e., having identical values of a property in all directions. Such isotropic materials are often better suited for shaping, independent from the shaping technology.

The first material comprises or consists of a material selected from the group consisting of:
metals, preferably titanium, nickel, chromium, niobium, tungsten, tantalum, molybdenum, vanadium, platinum, germanium, iron, and alloys thereof, in particular steel,
ceramics containing carbon and/or nitrogen or boron, preferably silicon carbide, silicon nitride, boron nitride, tantalum nitride, TiAlN, TiCN, and/or TiB₂,
glass ceramics; preferably aluminum-containing glass-ceramics,
composite materials made from ceramic materials in a metallic matrix (cermets),
hard metals, preferably sintered carbide hard metals, such as tungsten carbide or titanium carbide bonded with cobalt or nickel,
silicon or germanium, preferably with the crystalline plane parallel to the second face, wafer orientation <100>, <110>, <111> or <211>,
single crystalline materials,
glass or sapphire,
polycrystalline or amorphous silicon or germanium,
mono- or polycrystalline diamond, diamond like carbon (DLC), adamantine carbon and
combinations thereof.

The steels used for the first material are preferably selected from the group consisting of 1095, 12C27, 14C28N, 154CM, 3Cr13MoV, 4034, 40X10C2M, 4116, 420, 440A, 440B, 440C, 5160, 5Cr15MoV, 8Cr13MoV, 95X18, 9Cr18MoV, Acuto+, ATS-34, AUS-4, AUS-6 (=6A), AUS-8 (=8A), C75, CPM-10V, CPM-3V, CPM-D2, CPM-M4, CPM-S-30V, CPM-S-35VN, CPM-S-60V, CPM-154, Cronidur-30, CTS 204P, CTS 20CP, CTS 40CP, CTS B52, CTS B75P, CTS BD-1, CTS BD-30P, CTS XHP, D2, Elmax, GIN-1, H1, N690, N695, Niolox (1.4153), Nitro-B, S70, SGPS, SK-5, Sleipner, T6MoV, VG-10, VG-2, X-15T.N., X50CrMoV15, ZDP189.

It is preferred that the second material comprises or consists of a material selected from the group consisting of:
oxides, nitrides, carbides, borides, preferably aluminum nitride, chromium nitride, titanium nitride, titanium carbon nitride, titanium aluminum nitride, cubic boron nitride
boron aluminum magnesium
carbon, preferably diamond, poly-crystalline diamond, nano-crystalline diamond, diamond like carbon (DLC), and
combinations thereof.

Moreover, all materials cited in the VDI guideline 2840 can be chosen for the second material.

It is particularly preferred to use a second material of nano-crystalline diamond and/or multilayers of nano-crystalline and polycrystalline diamond as second material. In this regard, it was surprisingly found that cutting blades having a second material of nano-crystalline diamond layers, detachment, as is known of polycrystalline diamond, is suppressed. Relative to monocrystalline diamond, it has been shown that production of nano-crystalline diamond, compared to the production of monocrystalline diamond, can be accomplished substantially more easily and economically. Hence, also longer and larger-area cutting blades can be provided. Moreover, with respect to their grain size distribution nano-crystalline diamond layers are more homogeneous than polycrystalline diamond layers, the material also shows less inherent stress. Consequently, macroscopic distortion of the cutting edge is less probable.

It is preferred that the second material has a thickness of 0.15 to 20 μm, preferably 2 to 15 μm and more preferably 3 to 12 μm.

It is preferred that the second material has a modulus of elasticity (Young's modulus) of less than 1,200 GPa, preferably less than 900, and more preferably less than 750 GPa. Due to the low modulus of elasticity the hard coating becomes more flexible and more elastic and may be better adapted to the substrate, object or the contour to be cut. The Young's modulus is determined according to the method as disclosed in Markus Mohr et al., “Youngs modulus, fracture strength, and Poisson's ratio of nanocrystalline diamond films”, J. Appl. Phys. 116, 124308 (2θ14), in particular under paragraph III. B. Static measurement of Young's modulus.

The second material has preferably a transverse rupture stress Go of at least 1 GPa, more preferably of at least 2.5 GPa, and even more preferably at least 5 GPa.

With respect to the definition of transverse rupture stress Go, reference is made to the following literature references:
R. Morrell et al., Int. Journal of Refractory Metals & Hard Materials, 28 (2010), p. 508-515;
R. Danzer et al. in “Technische keramische Werkstoffe”, published by J. Kriegesmann, HvB Press, Ellerau, ISBN 978-3-938595-00-8, chapter 6.2.3.1 “Der 4-Kugelversuch zur Ermittlung der biaxialen Biegefestigkeit spröder Werkstoffe”

The transverse rupture stress Go is thereby determined by statistical evaluation of breakage tests, e.g., in the B3B load test according to the above literature details. It is thereby defined as the breaking stress at which there is a probability of breakage of 63%.

Due to the extremely high transverse rupture stress of the second material the detachment of individual crystallites from the second material, in particular from the cutting edge, is almost completely suppressed. Even with long-term use, the cutting blade therefore retains its original sharpness.

The second material has preferably a hardness of at least 20 GPa. The hardness is determined by nanoindentation (Yeon-Gil Jung et. al., J. Mater. Res., Vol. 19, No. 10, p. 3076).

The second material has preferably an surface roughness R_{RMS} of less than 100 nm, more preferably less than 50 nm, and even more preferably less than 20 nm, which is calculated according to

$${R}_{RMS} = ( \frac{1}{A} ) \int \int {Z ( x , y )}^{2} dxdy$$

A=evaluation area
Z(x,y)=the local roughness distribution

The surface roughness R_{RMS} is determined according to DIN EN ISO 25178. The mentioned surface roughness makes additional mechanical polishing of the grown second material superfluous.

In a preferred embodiment, the second material has an average grain size d₅₀ of the nano-crystalline diamond of 1 to 100 nm, preferably 5 to 90 nm and more preferably from 7 to 30 nm, and even more preferably 10 to 20 nm. The average grain size d₅₀ may be determined using X-ray diffraction or transmission electron microscopy and counting of the grains.

It is preferred that the first material and/or the second material is/are coated at least in regions with a low-friction material, preferably selected from the group consisting of fluoropolymer materials (like PTFE), parylene, polyvinylpyrrolidone, polyethylene, polypropylene, polymethyl methacrylate, graphite, diamond-like carbon (DLC) and combinations thereof.

The edge connecting the primary bevel and the secondary bevel is preferably shaped within the second material.

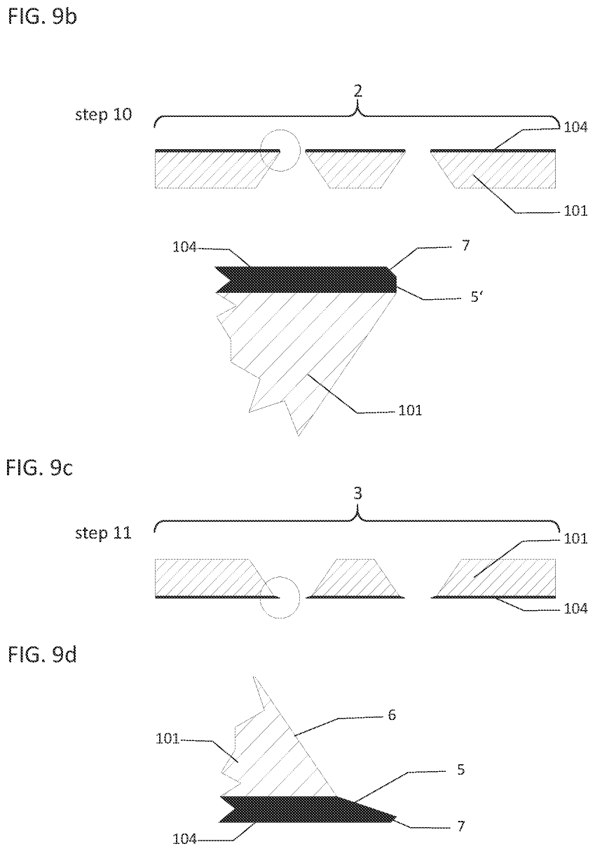

It is further preferred that the edge between secondary and tertiary bevel is arranged at the boundary surface of the first material and the second material which makes the process of manufacture easier to handle and therefore more economic, e.g., the blades can be manufactured according to the process of FIG. 9a-d.

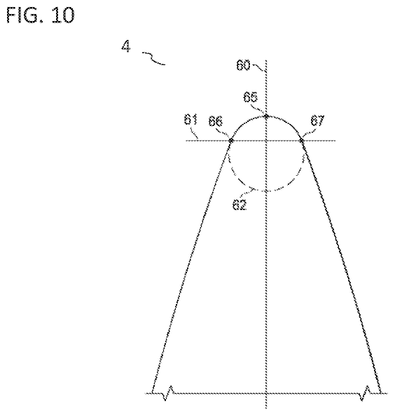

The cutting edge ideally has a round configuration which improves the stability of the blade. The cutting edge has preferably a tip radius of less than 200 nm, more preferably less than 100 nm and even more preferably less than 50 nm determined e.g., by cross sectional SEM using the method illustrated in FIG. 10.

It is preferred that the tip radius r of the cutting edge correlates with the average grain size d50 of the hard coating. It is hereby advantageous if the ratio between the rounded radius r of the nano-crystalline diamond as second material at the cutting edge and the average grain size d50 of the nano-crystalline diamond as second material r/d50 is from 0.03 to 20, preferably from 0.05 to 15, and particularly preferred from 0.5 to 10.

Turning now to FIG. 1, a shaving device 100 is shown. The shaving device 100 has a grip 150 which is attached to a housing 200. The housing comprises a forward skin support 210, a rearward skin support 220 and in between at least one blade 1 of the present invention.

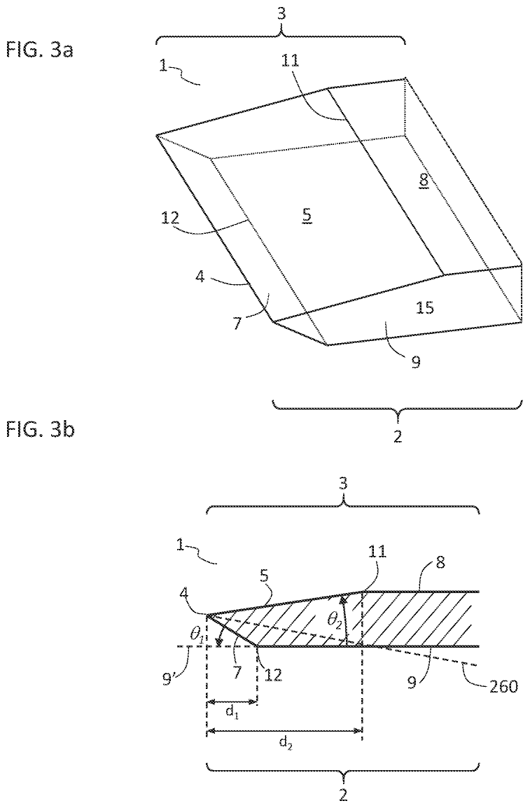

FIG. 2 shows a cross-sectional view of a shaving device 100 with the housing 200 and its forward skin support 210 and rearward skin support 220. It represents a cross-sectional view of the section A-A of FIG. 1. Between the supports two blades 1 and 1′ are arranged. In addition, more than two (2) blades may be arranged in the housing, e.g., three or four blades. During shaving the forward skin support 210, the rearward skin support 220 as well as the blades 1 and 1′ are in direct contact with the skin 310. The shaving device 100 has a skin contacting surface 250 being in direct, preferably plane contact to the skin 310. The skin contacting surface is the connecting line between the forward skin support 210 and the rearward skin support 220.

FIG. 3a is a perspective view of a cutting blade according to the present invention. This cutting blade 1 has a blade body 15 which comprises a first face 2 and a second face which is opposed to the first face 2. The first face 2 comprises a first surface 9 and a primary bevel 7 while the second surface 3 comprises a secondary bevel 5 and an upper surface 8 being parallel to the first surface 9. At the intersection of the primary bevel 7 and the secondary bevel 5 a cutting edge 4 is located. The cutting edge 4 is shaped straightly or substantially straightly. The secondary bevel 5 is connected to the upper surface 8 via an intersecting line 11 and the primary bevel 5 is connected to the first surface 9 via an intersecting line 12.

In FIG. 3b, a cross-sectional view of the cutting blade of FIG. 3a is shown. This cutting blade 1 comprises a first face 2 and a second face 3 which is opposed to the first face 2. The first face 2 comprises a plane first surface 9 and a primary bevel 7 with a first wedge angle θ₁ between the first surface 9 and the primary bevel 7. The second face 3 comprises a secondary bevel 5 with a second wedge angle θ₂ between the first surface 9 and the secondary bevel 5 which is smaller than θ₁. Moreover, the second face 3 comprises an upper surface 8. At the intersection of the primary bevel 7 and the secondary bevel 5 a cutting edge 4 is located. The secondary bevel 5 is connected to the upper surface 8 via an intersecting line 11 and the primary bevel 5 is connected to the first surface 9 via an intersecting line 12. The primary bevel 7 has a length d₁ being the dimension projected onto the first surface 9 which is in the range from 0.5 to 5 μm. The secondary bevel 6 has a length d₂ being the dimension projected onto the first surface 9 which is in the range from 5 to 75 μm, preferably 15 to 35 μm.

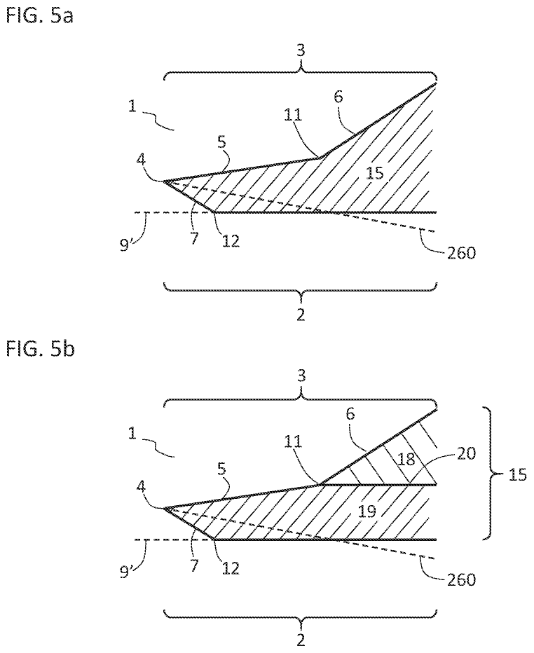

FIG. 4a is a perspective view of the cutting blade according to the present invention. This cutting blade 1 has a blade body 15 which comprises a first face 2 and a second face 3 which is opposed to the first face 2. The first face 2 comprises a first surface 9 and a primary bevel 7 while the second surface 3 comprises a secondary bevel 5 and a tertiary bevel 6. The primary bevel 7 is connected via a first intersecting line 12 with the first face 9 and the secondary bevel 5 is connected via a second intersecting line 11 with the tertiary bevel 6. At the intersection of the primary bevel 7 and the secondary bevel 5 a cutting edge 4 is located. The cutting edge 4 is shaped linearly.

In FIG. 4b, a cross-sectional view of the cutting blade of FIG. 4a is shown. This cutting blade 1 comprises a first face 2 and a second face 3 which is opposed to the first face 2. The first face 2 comprises a plane first surface 9 and a primary bevel 7 with a first wedge angle θ₁ between the first surface 9 and the primary bevel 5. The second face 3 comprises a secondary bevel 5 with a second wedge angle θ₂ between the first surface 9 and the secondary bevel 6 which is smaller than θ₁. The tertiary bevel 6 has a third wedge angle θ₃ which is larger than θ₂. At the intersection of the primary bevel 7 and the secondary bevel 5 a cutting edge 4 is located. The primary bevel 7 has a length d₁ being the dimension projected onto the first surface 9 which is in the range from 0.5 to 5 μm. The secondary bevel 5 has a length d₂ being the dimension projected onto the first surface 9 which is in the range from 5 to 75 μm, preferably 15 to 35 μm.

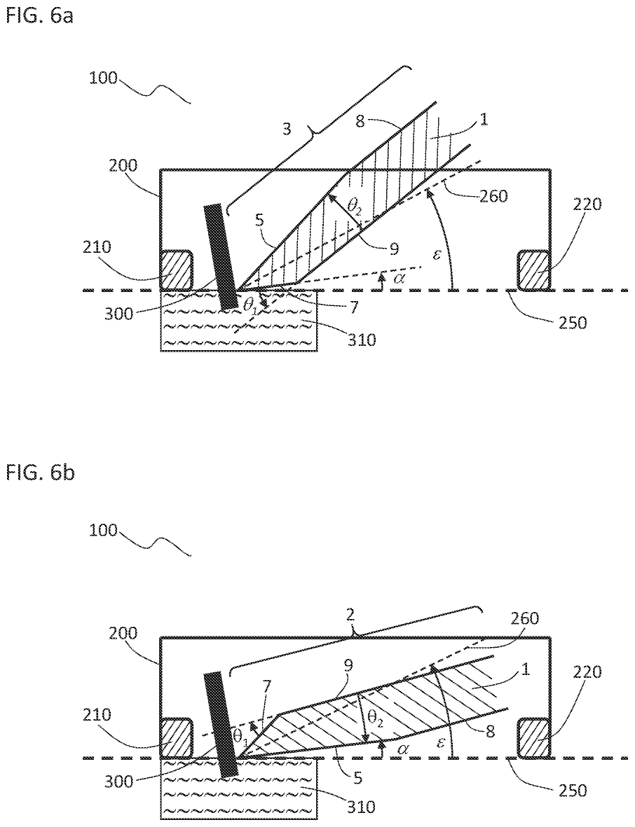

In FIG. 5a, a further sectional view of a cutting blade of the present invention is shown where the blade body 15 is monolithic. The cutting blade 1 comprises a first face 2 and a second face 3 which is opposed to the first face 2. The first face 2 comprises a plane first surface 9 and a primary bevel 7 while the second surface 3 comprises a secondary bevel 5 and a tertiary bevel 6. The primary bevel 7 is connected via a first intersecting line 12 with the first face 9 and the secondary bevel 5 is connected via a second intersecting line 11 with the tertiary bevel 6. At the intersection of the primary bevel 7 and the secondary bevel 5 the cutting edge 4 is located.

In FIG. 5b, a further sectional view of a cutting blade of the present invention is shown wherein the blade body 15 comprises a first material 18, e.g., silicon, with a second material 19, e.g., a diamond layer on the first material 18 at the first face 2. The primary bevel 7 and the secondary bevel 5 are located in the second material 19 while the tertiary bevel 6 is located in the first material 18. The first material 18 and the second material 19 are joined along a boundary surface 20.

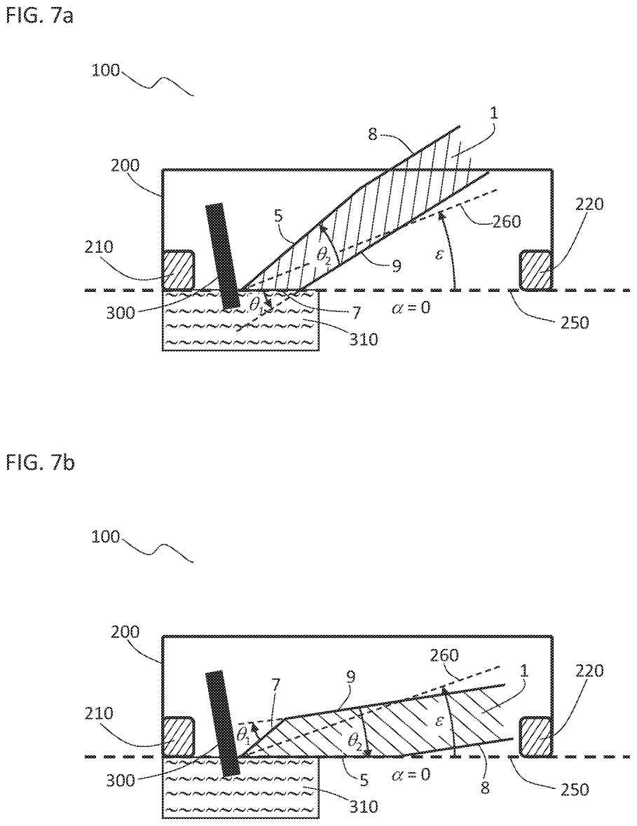

In FIG. 6a, a shaving device 100 of the present invention is shown illustrating the cutting process for a hair 300 which protrudes from the skin 310. The shaving device 100 comprises a housing 200 with a forward skin support 210 and a rearward skin support 220. Between both supports 210, 220 a blade 1 is arranged. The shaving device 100 with the skin contacting surface 250 is brought in contact with the skin 310. The hair 300 which is protruding from the skin 310 is touched by the cutting edge of the cutting blade 1. The cutting blade 1 has a first face 2 and a second face 3. According to this embodiment, the first face 2 is the clearance face. The first face 2 comprises a plane first surface 9 and a primary bevel 7 while the second surface 3 comprises a secondary bevel 6 and a surface 8 which is parallel to the first surface 9. The clearance angle α between the primary bevel 7 and the skin contacting surface 250 is larger than 0° but smaller or equal 11° which results in a high skin safety. Moreover, due to the asymmetric cross-sectional shape of the cutting blade 1 a larger effective cutting angle ε between the skin contacting surface 250 and the bisecting line 260 of the first wedge angle θ₁ may be realized, i.e., ε≥10°, which improves the efficiency of the hairs being cut.

In FIG. 6b, a shaving device 100 of the present invention is shown illustrating the cutting process for a hair 300 which protrudes from the skin 310. The shaving device 100 comprises a housing 200 with a forward skin support 210 and a rearward skin support 220. Between both supports 210, 220 a blade 1 is arranged. The shaving device 100 with the skin contacting surface 250 is brought in contact with the skin 310 and the hair 300 which protrudes from the skin 310 is touched by the cutting edge of the cutting blade 1. According to this embodiment, the second face 3 is the clearance face. The clearance angle α between the secondary bevel 5 and the skin contacting surface 250 is larger than 0° but smaller or equal 11° which results in a high skin safety. Moreover, due to the asymmetric cross-sectional shape of the cutting blade 1 a larger effective cutting angle ε between the skin contacting surface 250 and the bisecting line 260 of the first wedge angle θ₁ may be realized, i.e., ε≥10°, which improves the efficiency of the hairs being cut.

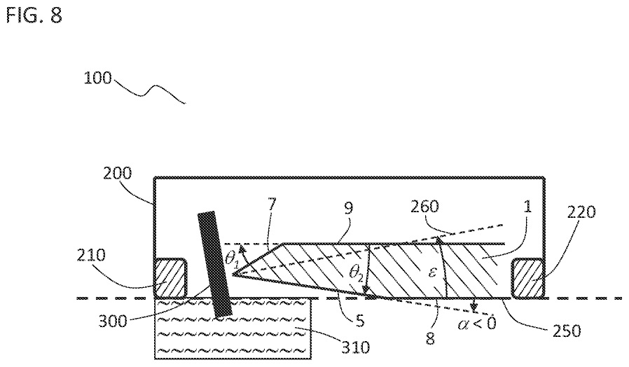

In FIG. 7a, a shaving device 100 of the present invention is shown illustrating the cutting process for a hair 300 which protrudes from the skin 310. The shaving device 100 comprises a housing 200 with a forward skin support 210 and a rearward skin support 220. Between both supports 210, 220 a blade 1 is arranged. The shaving device 100 with the skin contacting surface 250 is brought in contact with the skin 310 and the hair 300 which is sticking out of the skin 310 is touched by the cutting edge 4 of the cutting blade 1. In this embodiment, the first face 2 is the clearance face. The clearance angle α between the primary bevel 7 and the skin contacting surface 250 is 0° which results in a high skin safety. Moreover, due to the asymmetric cross-sectional shape of the cutting blade 1 a larger effective cutting angle ε between the skin contacting surface 250 and the bisecting line 260 of the first wedge angle θ₁ may be realized, i.e., ε≥10°, which improves the efficiency of the hair cutting.

In FIG. 7b, a shaving device 100 of the present invention is shown illustrating the cutting process for a hair 300 which sticks out of the skin 310. The shaving device 100 comprises a housing 200 with a forward skin support 210 and a rearward skin support 220. Between both supports 210, 220 a blade 1 is arranged. The shaving device 100 with the skin contacting surface 250 is brought in contact with the skin 310 and the hair 300 which is sticking out of the skin 310 is touched by the cutting edge 4 of the cutting blade 1. In this embodiment, the second face 2 is the clearance face. The clearance angle α between the second face 2 with the secondary bevel 5 of the cutting blade 1 and the skin contacting surface 250 is 0° which improves the skin safety. Moreover, due to the asymmetric cross-sectional shape of the cutting blade 1 a larger effective cutting angle ε between the skin contacting surface 250 and the bisecting line 260 of the first wedge angle θ₁ can be realized, i.e., ε≥10°, which improves the efficiency of the hair cutting.

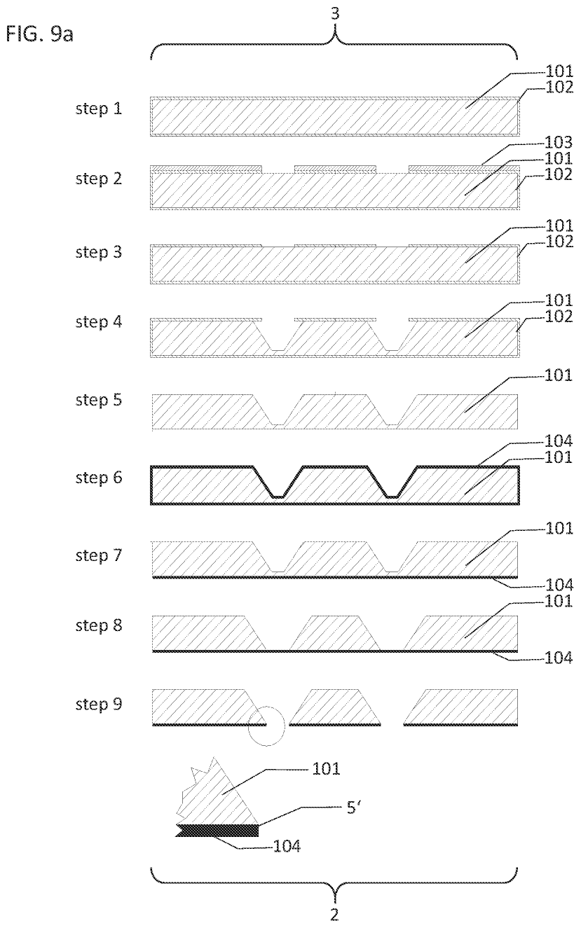

In FIG. 8, a shaving device 100 of the present invention is shown illustrating the cutting process for a hair 300 which sticks out of the skin 310. The shaving device 100 comprises a housing 200 with a forward skin support 210 and a rearward skin support 220. Between both supports 210, 220 a blade 1 is arranged. The shaving device 100 with the skin contacting surface 250 is brought in contact with the skin 310 and the hair 300 which is sticking out of the skin 310 is touched by the cutting edge 4 of the cutting blade 1. In this embodiment, the second face 2 is the clearance face. The clearance angle α between the second face 2 with the secondary bevel 5 of the cutting blade 1 and the skin contacting surface 250 is smaller than 0° which improves the skin safety. Moreover, due to the asymmetric cross-sectional shape of the cutting blade 1 a larger effective cutting angle ε between the skin contacting surface 250 and the bisecting line 260 of the first wedge angle θ₁ can be realized, i.e., ε≥10°, which improves the efficiency of the hair cutting.

In FIG. 9a to 9d, a flow chart of the inventive process is shown. In a first step 1, a silicon wafer 101 is coated by PE-CVD or thermal treatment (low pressure CVD) with a silicon nitride (Si₃N₄) layer 102 as protection layer for the silicon. The layer thickness and deposition procedure must be chosen carefully to enable sufficient chemical stability to withstand the following etching steps. In step 2, a photoresist 103 is deposited onto the Si₃N₄ coated substrate and subsequently patterned by photolithography. The (Si₃N₄) layer is then structured by e.g., CF₄-plasma reactive ion etching (RIE) using the patterned photoresist as mask. After patterning, the photoresist 103 is stripped by organic solvents in step 3. The remaining, patterned Si₃N₄ layer 102 serves as a mask for the following pre-structuring step 4 of the silicon wafer 101 e.g., by anisotropic wet chemical etching in KOH. The etching process is ended when the structures on the second face 3 have reached a predetermined depth and a continuous silicon first face 2 remains. Other wet- and dry chemical processes may be suited, e.g., isotropic wet chemical etching in HF/HNO₃ solutions or the application of fluorine containing plasmas. In the following step 5, the remaining Si₃N₄ is removed by, e.g., hydrofluoric acid (HF) or fluorine plasma treatment. In step 6, the pre-structured Si-substrate is coated with an approx. 10 μm thin diamond layer 104, e.g., nano-crystalline diamond. The diamond layer 104 can be deposited onto the pre-structured second surface 3 and the continuous first surface 2 of the Si-wafer 101 (as shown in step 6) or only on the continuous first surface 2 of the Si-wafer (not shown here). In the case of double-sided coating, the diamond layer 104 on the structured second surface 3 is removed in a further step 7 prior to the following edge formation steps 9-11 of the cutting blade. The selective removal of the diamond layer 104 is performed e.g., by using an Ar/O₂-plasma (e.g., RIE or ICP mode), which shows a high selectivity towards the silicon substrate. In step 8, the silicon wafer 101 is thinned so that the diamond layer 104 is partially free standing without substrate material and the desired substrate thickness is achieved in the remaining regions. This step can be performed by wet chemical etching in KOH or HF/HNO₃ etchants or preferably by plasma etching in CF₄, SF₆, or CHF₃ containing plasmas in RIE or ICP mode.

In a next step 9, the diamond film is etched anisotropically by an Ar/O₂-plasma in an RIE system to form an almost vertical bevel 5′ with a 900 corner in the diamond layer 104, which is required to form primary bevel 7 on the first face 2 of the cutting blade as shown in step 10.

To form primary bevel 7 on the first face 2 of the cutting blade, the Si-wafer 101 is now turned to expose the first face 2 to the subsequent etching step 10 (FIG. 9b). By utilizing a physical enriched anisotropic RIE process in Ar/O₂-plasma the 90° corner 5′ is chamfered to form primary bevel 7. Process details are disclosed for instance in EP 2 727 880.

Finally, in step 11 (FIG. 9c) the cutting edge formation is completed by processing the Si-wafer 101 on the second face 3 to form secondary bevel 5 as shown in FIG. 9d. Multiple bevels may be formed by varying the process parameters. Process details are disclosed for instance in DE 198 59 905 A1.

Lastly, in FIG. 10, it is shown how the tip radius can be determined. The tip radius is determined by first drawing a line 60 bisecting the cross-sectional image of the first bevel of the cutting edge 1 in half. Where line 60 bisects the first bevel point 65 is drawn. A second line 61 is drawn perpendicular to line 60 at a distance of 110 nm from point 65. Where line 61 bisects the first bevel two additional points 66 and 67 are drawn. A circle 62 is then constructed from points 65, 66 and 67. The radius of circle 62 is the tip radius for coated blade 1.

The illustrations presented herein are not intended to be actual views of any particular substrate, apparatus (e.g., device, system, etc.), or method, but are merely idealized and/or schematic representations that are employed to describe and illustrate various embodiments of the disclosure.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm” or ±10% of the disclosed dimension.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A shaving device for shaving a skin surface comprising:
a housing with a skin contacting surface and
at least one cutting blade mounted in the housing, wherein the at least one cutting blade has an asymmetric cross-sectional shape with a first face, a second face opposed to the first face as well as a cutting edge at the intersection of the first face and the second face, wherein:
the first face comprises a first surface and a primary bevel with
the primary bevel extending from the cutting edge to the first surface,
a first intersecting line connecting the primary bevel and the first surface and
a first wedge angle θ₁ between an imaginary extension of the first surface and the primary bevel and
the second face comprises a secondary bevel with
the secondary bevel extending from the cutting edge, and
a second wedge angle θ₂ between the first surface and the secondary bevel,
wherein the at least one cutting blade is mounted in the housing that
the clearance angle α between the skin contacting surface and the primary bevel or the secondary bevel (5) is ≤11°;
the effective cutting angle ε between the skin contacting surface and the bisecting line of the first wedge angle θ₁ is ≥10°; and
θ₁>θ₂.

2. The shaving device of claim 1, wherein the clearance angle α is ≤5°, ≤1°, ≤0° or ranging from −1° to −5° and/or the effective cutting angle ε is ≥15°.

3. The shaving device of claim 1, wherein the second face comprises a tertiary bevel, extending from the second bevel with a second intersecting line connecting the secondary bevel and the tertiary bevel and a third wedge angle θ₃ between the first surface and the tertiary bevel, wherein θ₂ is smaller than θ₃.

4. The shaving device of claim 1, wherein the first wedge angle θ₁ ranges from 5° to 75°, 10° to 60°, or 15° to 45° and/or the second wedge angle θ₂ ranges from −10° to 40°, 0° to 30°, or 10° to 25° and/or the third wedge angle θ₃ ranges from 1° to 60°, 10° to 55°, 19° to 46° or 20 to 45°.

5. The shaving device of claim 1, wherein the primary bevel has a length d₁ being the dimension projected onto the imaginary extension of the first surface taken from the cutting edge to the first intersecting line from 0.1 to 7 μm, from 0.5 to 5 μm, or from 1 to 3 μm.

6. The shaving device of claim 3, wherein the dimension projected onto the first surface and/or the imaginary extension of the first surface taken from the cutting edge to the second intersecting line has a length d₂ which ranges from 1 to 75 μm.

7. The shaving device of claim 1, wherein the cutting blade comprises a blade body comprising a first material.

8. The shaving device of claim 1, wherein the cutting blade comprises a blade body comprising or consisting of a first material and a second material joined with the first material.

9. The shaving device of claim 1, wherein the first material comprises a material selected from the group consisting of:
Metals comprising titanium, nickel, chromium, niobium, tungsten, tantalum, molybdenum, vanadium, platinum, germanium, iron, and alloys thereof, and steel;
ceramics containing carbon and/or nitrogen or boron, silicon carbide, silicon nitride, boron nitride, tantalum nitride, TiAlN, TiCN, and/or TiB₂;
glass ceramics, aluminum-containing glass-ceramics;
composite materials made from ceramic materials in a metallic matrix (cermets);
hard metals, sintered carbide hard metals, such as tungsten carbide or titanium carbide bonded with cobalt or nickel;
silicon or germanium, with or without the crystalline plane parallel to the second face (2) orientation <100>, <110>, <111> or <211>;
single crystalline materials;
glass or sapphire;
polycrystalline or amorphous silicon or germanium;
mono- or polycrystalline diamond, diamond like carbon (DLC), adamantine carbon; and
combinations thereof.

10. The shaving device of claim 8, wherein the second material comprises a material selected from the group consisting of:
oxides, nitrides, carbides, borides, including aluminum nitride, chromium nitride, titanium nitride, titanium carbon nitride, titanium aluminum nitride, cubic boron nitride;
boron aluminum magnesium;
carbon, diamond, nano-crystalline diamond, diamond like carbon (DLC); and
combinations thereof.

11. The shaving device of claim 8, wherein the second material fulfills at least one of the following properties:
a thickness of 0.15 to 20 μm;
a modulus of elasticity of less than 1,200 GPa;
a transverse rupture stress Go of at least 1 GPa; and
a hardness of at least 20 GPa.

12. The shaving device of claim 8, wherein the second material (19) comprises nano-crystalline diamond and fulfills at least one of the following properties:
an average surface roughness R_{A} of less than 100 nm; and
an average grain size d₅₀ of the nano-crystalline diamond of 1 to 100 nm.

13. The shaving device of claim 8, wherein the first material and/or the second material are coated at least in regions with a low-friction material, wherein said low-friction material comprises fluoropolymer materials, parylene, polyvinylpyrrolidone, polyethylene, polypropylene, polymethyl methacrylate, graphite, diamond-like carbon (DLC) and combinations thereof.

14. The shaving device of claim 8, wherein the first intersecting line is shaped within the second material.

15. The shaving device of claim 1, wherein the cutting edge has a tip radius of less than 200 nm.

16. The cutting blade of claim 1, wherein the secondary bevel comprises a further beveled region extending from the cutting edge to a third intersecting line connecting the secondary bevel and the beveled region, the beveled region having a fourth wedge angle θ₄ between the first surface and the beveled region.
